(19) United States
(12) Patent Application Publication
(10) Pub. No.: US 2026/0102318 A1
(43) Pub. Date: Apr. 16, 2026

(54) COMPLIANT INFANT SUCKLING DEVICE

(71) Applicant: Momtech, Inc., Matthews, NC (US)

(72) Inventors: Carr Lane Quackenbush, Monson, MA (US); Harold R. Eason, Indian Trail, NC (US)

(73) Assignee: Momtech, Inc., Matthews, NC (US)

(21) Appl. No.: 19/360,165

(22) Filed: Oct. 16, 2025

Related U.S. Application Data
(60) Provisional application No. 63/707,842, filed on Oct. 16, 2024.
(60) Provisional application No. 63/757,495, filed on Feb. 12, 2025.

(51) Int. Cl. A61J 11/00; A61J 11/04; A61J 17/00

(52) U.S. Cl. CPC A61J 11/0015; A61J 11/0065; A61J 11/045; A61J 17/001

(57) ABSTRACT

Nutritive and non-nutritive suckling devices made entirely of a soft, highly deformable elastomer includes a completely and/or partially filled nipple portion constructed of a low durometer elastomer. For nipple feeding, one or more ducts longitudinally extend through the completely-filled nipple portion. The nipple portion has sufficient axial strength to pass biting and elongation failure in regulatory testing yet is sufficiently radially compliant that a <8 PSI transverse compressive pressure can compress the nipple duct(s) to shut off fluid flow. An attachment design allows the soft highly deformable elastomer of the nipple base to resist detachment from the bottle collar when screwed onto the bottle under >20 pounds axial load. A non-nutritive pacifier device includes a completely-filled nipple portion having an open interior volume portion with a wall thickness adjusted to replicate the feel of a human nipple and an areola wall thickness sufficient to resist collapse during use.

### CROSS-REFERENCE TO RELATED APPLICATIONS

This application claims the benefit of U.S. Provisional Application Nos. 63/707,842, filed Oct. 16, 2024, and 63/757,495, filed Feb. 12, 2025, the entireties of which are hereby incorporated by reference.

### TECHNICAL FIELD OF THE INVENTION

The present invention relates to devices used for nutritive and non-nutritive infant suckling, and, more particularly to artificial teats and pacifiers that are designed to mimic properties of natural teats and the action of those natural teats in an infant's mouth whether used for feeding or calming.

### BACKGROUND OF THE INVENTION

Newborns and infants experience many benefits from breastmilk feeding that are well-documented in the scientific literature. Generally, the benefits of breastfeeding are attributed to the unique chemical composition of breastmilk. These benefits include providing protection against many illnesses caused by allergies, bacteria and viruses, such as stomach viruses, respiratory illness, ear infections, meningitis and the like. (See Fallot M. E., Boyd J. L., Oski F. A., Breast-feeding reduces incidence of hospital admissions for infection in infants; Pediatrics, 1980, 65:1121-1124). Feeding breast milk also may protect against Sudden Infant Death Syndrome, increase intelligence, decrease malocclusions. and fight obesity.

There are also benefits for mothers, as twenty-four cumulative months of breast-feeding are reputed to halve the risks of breast cancer and osteoporosis.

In addition to the known benefits of breastmilk's composition, there is growing evidence that the mode of delivery is very important to a baby's health and development. During nursing, an infant executes a complex sequence of coordinated suction and mechanical tongue motions called the “suck-swallow-breathe” rhythm. During this sequence, the nipple portion of a natural teat functions in a very specific way. (See McClellan, H. L., Sakalidis, V. S., Hepworth, A. R., Hartmann, P. E. and Geddes, D. T., Validation of Teat Cross Section and Tongue Movement Measurements with B-Mode Ultrasound During Breastfeeding, Ultrasound in Medicine & Biology; 2010 36 (11):1797-1807).

The steps of the suck-swallow-breathe rhythm are outlined below:
1. Initially, the infant's tongue compresses the nipple against the roof (hard palate) of the mouth and squeezes the internal milk ducts in the nipple closed, thereby shutting off milk flow. This position is known as the “fully up” position. Swallowing of extracted milk then ensues.
2. After swallowing, the infant's tongue begins dropping from the fully up position, unclamping the nipple ducts. This action initiates the “suck” phase where the downward tongue motion increases volume within the infant's mouth and thus creates suction which draws milk through the (now open) nipple ducts into the infant's oral cavity. The infant stops the tongue down-motion when sufficient milk has been extracted.
3. Finally, the infant's tongue starts back up stopping suction and milk extraction until it is again at the fully-up position, compressing the nipple against the roof (hard palate) of the mouth, thereby squeezing the milk ducts closed, and shutting off unwanted milk flow that might otherwise cause gagging. At this point, the infant again swallows, evacuating a substantial majority of the milk from the oral cavity.

This milk extraction rhythm is significant effort for the infant. That effort and the fact that, in breastfeeding, milk extraction occurs with very specific intensity, direction, sequencing, etc., gives benefits nature designed. Breastfeeding is work. The vigorous muscle action strengthens jaw muscles. Those muscles pull on their attachments causing bones of the jaw, hard palate, and skull to develop in form and proportion to the forces exerted. This results in a beneficial reshaping of craniofacial bones and teeth. (See Kevin Boyd, Darwinian Dentistry, J Am Orthodontic Soc., March/April 2012, pgs. 28-32). This is nature's design. For example, repeated nipple compression against the roof of the mouth (which in newborns is soft) causes the infant's palate to broaden into a low U-shaped arch. A palate having such a low arched shape does not intrude into the sinuses and allows development of properly aligned teeth. (See Palmer, B., The Influence of Breastfeeding on the Development of the Oral Cavity: A Commentary, J Human Lactation, 1998: 14 (2): 93-98). Moreover, research shows that because of the effort required for natural breastfeeding, the infant tires and stops feeding when satiated. This self-regulation avoids over-feeding giving reduced weight gain and potentially a lower incidence of obesity. (See Ruowei Li, et al.; Risk of Bottle-feeding for Rapid Weight Gain During the First Year of Life, Arch Pediatr Adolesc Med., 2012;166(5):431-436.)

### Benefits of Non-Nutritive Suckling

Non-nutritive suckling is a natural continuation of nutritive suckling wherein the infant suckles at the breast while not extracting breast milk. In alternating between nutritive and non-nutritive suckling, the human nipple does not change its properties and biomechanical actions involved in non-nutritive suckling are like breastfeeding.

The benefits of non-nutritive sucking are calming and comforting as well as pain management e.g., for infants undergoing minor surgical procedures. Like breastfeeding, the effort of non-nutritive suckling can strengthen craniofacial muscles and contribute to a well-developed palate and sinuses. Non-nutritive suckling can also assist infants in developing an organized suck-swallow-breathe rhythm which can strengthen or even restore breastfeeding. For premature infants, non-nutritive suckling can speed the transition from tube feeding to oral feeding and may even shorten the time to NICU discharge.

### Design Requirements for Baby Bottle Nipples and Pacifiers

Because baby bottle nipples and pacifiers both seek to replicate properties of the human nipple and the same biomechanical muscle action as natural nutritive and/or non-nutritive suckling, the objectives of nipple and pacifier design are similar, except baby bottle nipples have ducts and bottle attachments, whereas pacifiers have mouth shields. The ideal artificial nipple or pacifier should require equivalence of effort and equivalence of function as the human nipple. Indeed, they should force the infant to use the proper oral mechanics that nature designed. Accordingly, an optimal compliant infant suckling device, a bottle nipple for nutritive suckling or a pacifier for non-nutritive suckling should have the following characteristics:
1. Soft and pliable to simulate tissue of the human nipple.
2. A structure that allows forces applied to the outside surface of the nipple or pacifier by the infant's tongue to be transmitted (in the case of an artificial feeding teat) through the filled nipple portion to compress and shut off fluid flow through the duct(s) to facilitate swallowing without gagging, or (in the case of a pacifier device) to reshape the nipple and proximal areola portions so they better conform to the shape of the infant's oral cavity rather than forcing, over time, the infant's oral cavity to be detrimentally reshaped by a stiff pacifier.
3. Nipple and areola portions that are deformable under pressure from the tongue, gums and lips yet have sufficient solidity and rigidity to not collapse during use.
4. Strong and sufficiently bite-resistant to guard against biting damage or detrimental elongation by an infant and thereby to avoid broken pieces and the introduction of choking hazards.
5. Having a sufficiently long and narrow nipple and areola so the infant can establish a deep latch, pulling the nipple/areola deep into its mouth and stretchy to allow elongation for proper positioning at the back of the mouth.

Additional requirements for the design of artificial suckling devices include:
1. The baby bottle nipple base attachment must pull in and reliably seat into the bottle collar and when sealingly attached to the bottle with a collar the nipple base flange must not pull out of the collar during regulatory testing or use.
2. The pacifier mouth shield should include a stiff material to decrease its flexibility thereby prevent the infant from swallowing the nipple and a handle or tab to provide a grip for easy insertion or removal from the infant's mouth.
3. To avoid creation of a choking hazard, the nipple, mouth shield and tab portions must be strongly bonded together.
4. Each must be manufacturable at an acceptable cost.

### Prior Art Baby Bottle Nipples

Prior art baby bottle nipples do not have most of the above-mentioned desired properties or require the natural biomechanical suckling action ideal for infant suckling. As a result, prior art baby bottle nipple designs do not provide the benefits associated with natural breastfeeding. Notably, prior art baby bottle nipples, such as those illustrated in FIGS. 1 and 2, are very different in properties and geometry from a mother's nipple in the mouth of an infant during breastfeeding. Further, the muscle action used for feeding from these, and literally all, prior art baby bottle nipples is very different from that of natural breastfeeding. These differences require that the infant learn a milk extraction rhythm completely different than the natural nursing rhythm. As a result, the beneficial muscle action of natural nursing is lost, which can lead to improper development of the oral cavity and jaw bones, or lead to malocclusions and/or poorly developed sinuses. (See Palmer 1998). These undesirable effects of prior art baby bottle nipples can be permanent, causing lasting damage. In addition, prior art baby bottle nipples are less work for the nursing infant because they have open orifices giving easy and abundant flow. Studies with prior art nipples find the infant tends to empty the bottle regardless of liquid volume contained and regardless of whether it contains breastmilk or formula. Prior art baby bottle nipples are linked to a lack of self-regulation, over-feeding and excessive weight gain leading to childhood obesity. (See Peter T. Katzmarzyk et al., An Evolving Scientific Basis for the Prevention and Treatment of Pediatric Obesity, Int'l J. Obesity (London) July 2014, 38 (7), pp. 887-905).

The problems with prior art baby bottle nipples for nutritive suckling stem from their design which is imposed by their materials of construction. One engineering design challenge for baby bottle nipples is that all infants eventually get teeth, so prior art nipples are generally made from bite resistant materials, so to be safe against choking hazard should portions of the artificial device be torn off. Prior art feeding nipples generally use a high tear strength elastomer, for example silicone having a Shore A hardness between A50 and A70, which has good intrinsic bite resistance.

Unfortunately, such materials are hard, nearly as hard as a car tire. Nipples made from such high durometer materials typically stretch less than 10% the elongation of a human nipple during nursing.

FIG. 1 shows the cross section of a typical prior art single elastomer, wide-based baby bottle nipple. To make the nipple somewhat flexible, designers make them hollow, typically with open orifices at the nipple tip. Unlike a natural nipple, prior art nipples have no compression shutoff capability. Being hollow, not solid, and with open orifices, when the infant compresses the nipple with its tongue fluid flow continues. Worse, when compressed, many prior art nipples jet fluid into the infant's mouth. To cope, the infant must learn a completely new, non-natural, milk extraction rhythm. This “nipple confusion” can interfere with a return to breastfeeding.

The shape of some prior art feeding nipples is another problem. The nipple illustrated in FIG. 1 and particularly the prior art nipple illustrated in FIG. 2 are breast-shaped and have a sharp transition from nipple to their shallow-angled areolas. These prior art nipples mimic the mother's breast/nipple shape at rest. Unfortunately, this shape is completely different from the natural deformed shape of the nipple and areola in an infant's mouth during nursing. A wide, breast-shaped, shallow-angled areola contour can limit a deep latch causing the infant's lips to slide down the shallow-angled areola onto just the nipple; then it's like drinking from a straw. During breastfeeding a natural nipple and areola are significantly elongated, up to twice their rest length. It is this elongated shape that is important to the infant. To promote a deep latch, an ideal bottle nipple should be sufficiently long and narrow and the elastomer very stretchy so the infant can pull the teat deep into its mouth and elongate it for proper positioning at the back of the mouth. Breast-shaped prior art bottle nipples, as depicted in FIGS. 1 and 2, do not have this elongated shape or stretchy elastomer and as a result cannot adequately mimic natural nutritive suckling action.

### Prior Art Pacifier Problems

Prior art pacifiers cause similar problems to prior art bottle nipples because they also do not adequately replicate the human nipple in properties or biomechanical suckling action. If the mother's breast is not available, infants will often suck on thumbs or fingers or on an artificial teat commonly called a pacifier. Research links non-nutritive suckling on things other than the natural nipple to numerous negative outcomes: decreased breastfeeding duration, increased malocclusions, and abnormal craniofacial developments. (See, e.g., 0. Sabuncuoglu, Understanding the relationships between breastfeeding, malocclusion, ADHD, sleep-disordered breathing, and traumatic dental injuries, Medical Hypotheses, March 2013, Volume 80, Issue 3, pp 315-320).

Research shows high stiffness pacifiers tend to be rejected by infants and even though they are used for non-nutritive suckling, they can impact feeding outcomes. (See Zimmerman, E., Steven M. Barlow, Pacifier stiffness alters the dynamics of the suck central pattern generator, J. Neonat. Nurs., 2008, 2007.12.013).

### Prior Art Pacifier Designs

One type of prior art pacifier, namely, a unitary elastomer pacifier (1), is illustrated in FIG. 3. It includes a nipple portion (3) and, if present, an areola portion (4), and a mouth shield portion (5) including a tab or handle (6). The mouth shield (5) has a central hole (7) that typically aligns with the distal opening of the areola portion (4) which is contiguous with the interior volume of the nipple portion (3).

The entire structure (1) is made of a stiff elastomer typically having a Shore A hardness above 45. This high hardness allows the mouth shield portion (5) to be sufficiently stiff to keep the infant from swallowing the nipple and thereby to comply with U.S. Regulations 16 C.F.R. Part 1511. Since the pacifier (1) is a one-piece design, the nipple portion (3) and the areola portion (4) must also be constructed of the same high hardness elastomer. This single material configuration gives manufacturing ease, cost advantages and bite resistance, but results in a nipple portion (3) that is not soft and pliable or stretchy as desired to simulate the human nipple.

Most prior art pacifiers are of the design represented by FIG. 4. The illustrated pacifier (10) has a nipple/areola portion (11) and a mouth shield portion (13) including a tab or handle (15). The mouth shield portion (13) may or may not have a central hole (16) contiguous with the distal opening of the nipple/areola portion (11). The nipple/areola portion (11) is generally a single silicone of various geometries. The mouth shield portion (13) is generally hard plastic. Silicones do not easily bond to hard plastic, so the nipple/areola portion (11) is typically attached to the hard plastic mouth shield portion (13) using a mechanical attachment (14). The nipple/areola portion (11) is generally an elastomer having a Shore A hardness of about 50 or higher for bite resistance. While better replicating properties of the human nipple, softer silicones are not used due to risk of biting damage and/or attachment failure under hard pulling, for example by the soft elastomer necking down and pulling out of its pocket in the mouth shield portion (14), or by fracture of the hard mouth shield portion (14) around the attachment pocket. Patents such as European Patent No. EP 1933802B1 address elastomer nipple to hard plastic mouth shield attachment design problems.

Another prior art pacifier design is shown in FIG. 5. The illustrated pacifier (20) has an elastomer nipple/areola portion (21) and mouth shield portion (23) having a stiff mouth shield insert (25). The mouth shield portion (23) typically has a central hole (26) which aligns with the distal opening of the nipple/areola portion (21) which is further contiguous with interior volume of the nipple/areola portion (21). In this design, the silicone nipple/areola portion (21) can have a hardness of Shore A20. This softness can produce very compliant nipple and areola portions. However, some prior art pacifiers of this design, for example U.S. Pat. No. 10,285,912, use areola sidewalls as thin as 1 mm and claim that “the areola is configured to collapse” during use. Users find neither to be desirable. Moreover, such soft silicones and thin sidewalls make the pacifier susceptible to biting damage and, as a result, such a pacifier design generally does not pass EN 1400 standards. U.S. Pat. No. 10,285,912 also specifies that the Shore A20 silicone of the nipple/areola portion wrap completely around a rigid base ring (25) so that such a base ring (25) is “imbedded in the mouth shield” (23). This 3-layer mouth shield configuration requires further that the tab (24) must also be the same Shore A20 silicone of the nipple/areola portion (21) and the material that wraps completely around the rigid base ring (25). This softness may compromise a firm grip on the tab (24) for easy insertion or removal from the infant's mouth and the tab (24) may be too flexible to enable reliable attachment of a toy or pacifier strap.

Clearly, prior art baby bottle nipples and pacifiers do not replicate a natural nipple, not in properties, not in biomechanical action and it is documented that these bottle nipple or pacifier deficiencies cause damage. As a result, there is an important unmet need and significant commercial value for both nutritive and non-nutritive suckling devices that can be inexpensively manufactured with properties more like the human teat and supporting biomechanical muscle action more like natural nursing and nonnutritive suckling.

One might ask, why such artificial suckling devices have not yet been commercialized? They have not, and that fact clearly indicates that those skilled in the art have found the engineering and design challenges discussed and addressed herein too difficult to overcome and that potential designs are non-obvious. The present submission sets out to correct this deficiency.

### Engineering Challenges of Prior Art Baby Bottle Nipples

Achieving a feeding nipple that is soft, pliable, and stretchy for proper elongation, as well as solid and sufficiently compressible for fluid shut off and yet is strong, bite resistant and at the same time is manufacturable at a reasonable cost presents numerous design, engineering and manufacturing challenges. Some of these challenges include the following:
1. For compression shutoff, the nipple proximal end must be filled for an axial length of more than 4 mm and constructed of a soft, low durometer elastomer, e.g., Shore A1 to A30 durometer. Running through that filled nipple portion is a duct, having a very small diameter flow control zone. The duct pins used in injection molding to form this small-diameter duct are fragile and prone to breakage under the forceful injection of polymer during injection molding.
2 For compression shutoff, the nipple proximal end must be filled and constructed of a soft, low durometer elastomer, e.g., Shore A1 to A30 durometer. Unfortunately, tear strength—i.e., the property needed for bite resistance and elongation failure—decreases with decreasing durometer. The difficult engineering balance is to have enough cross-section of elastomer with sufficient tear strength to meet regulatory bite resistance and elongation tearing resistance requirements while being sufficiently compliant to allow compression shutoff to collapse the nipple duct(s) to stop fluid flow at <8 PSI compressive pressure.
3. To be manufacturable at an acceptable cost the entire baby bottle teat, including the nipple base attachment, should be constructed of the same soft, low durometer elastomer as the nipple portion. It is a challenge with such a soft, low durometer easily-deformed elastomer to design an attachment that prevents the nipple base flange from pulling out from the bottle collar in regulatory testing or in use.

Soft, low durometer baby bottle nipples with filled proximal ends and having compression shutoff are disclosed in U.S. Pat. No. 8,448,796 to Silver, U.S. Pat. No. 9,913,780 to Quackenbush and U.S. Pat. No. 11,471,379 to Quackenbush. U.S. Pat. Nos. 9,913,780 and 11,471,379 share inventors with the present invention and are incorporated herein by reference in their entireties.

All claims in U.S. Pat. No. 8,448,796 to Silver specify a “reinforcing element” in the solid nipple portion. As shown experimentally in U.S. Pat. No. 11,471,379, the stiffness and claimed positioning of these reinforcing elements “close to the duct(s)” result in a nipple requiring a radial compression of 16 PSI for nipple duct shutoff. A compression greater than 8 PSI is believed beyond an infant's tongue strength. Therefore, the compression shutoff scheme disclosed in U.S. Pat. No. 8,448,796 does not work. This is clearly evidenced by the fact that the nipples described in U.S. Pat. No. 8,448,796 have never been commercialized. Therefore, the design teachings of U.S. Pat. No. 8,448,796 are meaningless and so will not be discussed further.

The devices of U.S. Pat. Nos. 9,913,780 and 11,471,379, both to Quackenbush, as well as the present submission discussed further herein below, all demonstrate compression shutoff at <8 PSI and all can pass US and European regulations for bite and elongation tearing resistance testing. All claims in U.S. Pat. No. 9,913,780 as well as some nipple claims, and all pacifier claims of U.S. Pat. No. 11,471,379 specify a helically wound fiber mesh tube that surrounds and provides bite resistance to the soft nipple portion. Prior to molding, this helically wound fiber mesh is a supple, pliable textile material. In manufacturing, it is difficult to handle; in molding, it is hard to position properly within the nipple structure and difficult to maintain pitch of the helical fibers, all important for proper functioning of the fiber mesh tube. For these reasons, manufacturing is difficult, and cost is unacceptably high.

Other nipples claimed in U.S. Pat. No. 11,471,379, do not contain a helically wound fiber mesh tube; they have soft low durometer nipple portions and high durometer bases. One advantage of a high durometer nipple base is that it is easy to design a nipple base attachment that does not pull out from the bottle collar in regulatory testing or in use. The disadvantage of these multi-durometer nipples is that with each added elastomer, the cost to manufacture increases unacceptably.

### Teat to Bottle Attachment Design

The areola portion of prior art bottle nipples is connected at its distal end to a base portion configured to sealingly attach to a bottle containing fluid to be fed to the infant using an attachment collar as known in the art. The connection between bottle and collar is usually through complementary threads, which when tightened, clamp the annular nipple base attachment flange between the (distal) underside of the collar and the proximal top rim of the bottle. The geometry of the underside of the collar and the mating geometry of prior art nipples are both designed to pull through and seat into the collar but when screwed onto the bottle, the teat base flange should not pull out of the bottle collar when axially loaded during regulatory testing or use.

“Pull through” occurs when the nipple is pulled into the baby bottle collar to seat it before it is screwed onto the bottle. As depicted in FIG. 6, the proximal outer rim of the teat areola portion is first pulled through the inside diameter of the collar. As pull continues, the nipple should snap into the collar and resist further motion that would pull the nipple through and completely out of the collar. FIG. 7 shows the undesirable situation of a nipple just before it pulls through and out of the collar.

FIGS. 8-9 generally illustrate typical nipple/bottle connections for prior art baby bottle designs. After the teat and collar are screwed onto the bottle, to resist pullout there must be sufficient material outbound of the pinch point (marked by arrows (22) in FIGS. 8-9). The pinch point is the narrowest gap between the underside of the collar and the top rim of the bottle. If the base of the teat is a high-durometer elastomer, e.g., A50 to A70, it is relatively easy to design an attachment which is resistant to pull through and pull out. One commercial nipple design (FIG. 8) includes a large rim of elastomer (26) extending down outside the bottle top rim, outbound of the pinch point. Its size and the stiff A50-A70 material of its construction allow it to strongly resist pullout. However, a disadvantage of this design is that the large nipple attachment rim requires that the collar (27) must have a pocket for the nipple rim to fit into. To make such a pocket at the top of the threaded portion of the collar requires the collar to be made with an expensive collapsible core injection molding tool.

Collars that are not made with collapsible core tooling, but with an unscrewing tool, require that the threads go all the way to the top of the collar. This means that there can be no outbound pocket such as found with the collar shown in FIG. 8. An alternative collar design, shown in FIG. 9, is made in a less expensive unscrewing tool, not a collapsible core tool; threads can be seen to go to the top of the collar (29). If the teat base attachment flange in FIG. 9 is constructed of stiff A50-A70 elastomer, it can resist pullout from the collar with only a small mass of elastomer (28) beyond the pinch point (formed between the downward-facing tooth of the collar and the top rim of the bottle). However, if for cost and ease of manufacturing reasons, the nipple, areola, and base attachment flange of the teat are all made of the same soft and highly-deformable elastomer (e.g., A1 to A30) and if the attachment design of FIG. 9 is used, the teat base flange will pull out of the collar at less than 10 pounds, which is highly undesirable.

### Regulatory Mechanical Testing

The nutritive suckling nipple bite-resistance test defined in U.S. 16 C.F.R. Part 1500.51 is relatively easy to pass and will not be considered further in connection with the present nipple invention. By comparison, EN 14350, the European nipple regulatory test is far more stringent. This test simulates excessive biting damage and excessive nipple stretching by the infant. In this test the nipple portion of an artificial teat is punctured through its diameter with a chisel-pointed 3 mm diameter punch. This puncture simulates extreme infant biting damage. Then the (punctured) “feeding teat and drinking accessories” (taken to mean the teat mounted with a collar onto a bottle) is subjected to 90 N (about 20 pounds) load applied axially between the bottle and the nipple tip for 10 seconds. To pass, cracks emanating from the puncture must not extend, and the nipple must not rupture or pull out from its attachment to the bottle.

In evaluating the present baby bottle nipples, EN 14350 was used for mechanical evaluation of nipples that were soft and pliable and had sufficient compressibility that the at least one duct could be shut off and fluid flow inhibited at <8 PSI radial compressive pressure.

In evaluating the present pacifiers, the pacifier tests in US 16 1511 are easily met. The European regulatory pacifier test EN 1400 was used for mechanical evaluation of pacifiers that were soft and pliable and had sufficient compressibility to better conform to the shape of an infant's oral cavity

In embodiments of the present pacifier invention, the mouth shield was tested against U.S. safety regulation 16 C.F.R. Part 1511, “Requirements for Pacifiers”, which specifies that the mouth shield not be so small or flexible that it can be sucked into a child's mouth. 16 C.F.R. Part 1511 also specifies a pull test to evaluate attachment strength between nipple and mouth shield and between mouth shield and tab or handle, so neither the nipple, tab or handle can become detached and become a choking hazard.

### SUMMARY OF THE INVENTION

The present invention provides an infant suckling device, such as an artificial bite-safe nipple or teat, designed for use with a baby bottle for nutritive feeding, and a pacifier device, for use as a non-nutritive pacifier, each with sufficient axial strength to pass testing designed to simulate severe use and abuse, the biting damage and excessive stretching, by an infant, yet retaining sufficient “stretchiness” and radial compliance to be capable of compression shutoff by an infant and/or or reshaping to conform to the shape of the infant's oral cavity during suckling action.

In embodiments of a first aspect of the present invention—a baby bottle nipple device for nutritive suckling—a nutritive suckling device is provided which is axially strong and bite-resistant yet retains deformability both longitudinally, for proper in-mouth positioning, and transversely, as required for compression shutoff.

According to embodiments of the present invention, a nutritive infant suckling device comprises a nipple portion, an areola portion having a wall thickness to define a hollow interior, and a base portion. In preferred embodiments, the nipple portion includes a proximal end, a distal end, and an exterior surface, with a portion of the nipple portion at the proximal end thereof being completely filled (i.e., a “filled portion”) along a longitudinal length of the nipple portion from the proximal tip thereof toward the distal end thereof and having one or more duct(s) extending longitudinally therethrough. The remainder of the nipple portion towards the distal end thereof is partially filled (i.e., a “partially filled portion”) extending from the completely filled distal end of the nipple portion to the distal end of nipple portion. When partially filled, an open interior volume in the partially filled portion is formed which is contiguous with the distal end of the completely filled nipple portion and the at least one duct longitudinally disposed within the filled nipple portion.

According to embodiments of a nutritive baby bottle nipple device in accordance with the present invention, the exterior surface of the nipple portion can be cylindrical or oval-shaped, although other shapes are possible without departing from the principles and spirit of the present invention.

According to embodiments of a nutritive baby bottle nipple device in accordance with the present invention, the nipple portion is preferably constructed from a single low durometer elastomer having a hardness of about Shore A1 to about Shore A30 and having properties and cross-sectional areas sufficient to impart axial strength sufficient to withstand regulatory testing and expected biting damage and/or elongation tearing by an infant without compromising longitudinal deformability and radial compressibility, while retaining sufficient radial compliance to allow shutoff of fluid flow through the at least one duct (37) with <8 PSI transverse compressive pressure.

In embodiments of a nutritive baby bottle nipple device in accordance with the present invention, the areola portion is connected at its distal end to the base portion.

The base portion is preferably constructed of the same single elastomer as the nipple portion and the areola portion—namely, within the range of about Shore A1 to Shore A30. Further, the base portion has an opening that connects to the internal opening at the distal end of the areola portion, so there is a continuous fluid path from the opening in the nipple base portion to the at least one duct of the nipple portion.

In embodiments of a nutritive baby bottle nipple device in accordance with the present invention, the diameter of the at least one duct of the device can vary between distal and proximal ends of the filled nipple portion, provided there is a portion of the at least one duct with a small diameter and short length acting to control fluid flow rate through the at least one duct.

In embodiments of a nutritive baby bottle nipple device in accordance with the present invention, the at least one duct of the nutritive suckling device has a wider diameter at the distal end of the filled nipple portion than at the proximal end of the filled nipple portion. Still further, the diameter of the at least one duct preferably reduces from the distal end of the filled nipple portion to the proximal tip, or near the proximal tip, of the filled nipple portion gradually, in steps, or both. There may be one or more intermediate sections each having respective diameters between the largest and smallest diameters.

In embodiments of a nutritive baby bottle nipple device in accordance with the present invention, a fluid flow control zone of the at least one duct of the nutritive suckling device is located at or proximate to the extreme proximal end of the filled portion of the nipple portion to control dripping. Such a fluid control zone can be provided by a small orifice at the tip of the nipple device.

In embodiments of a nutritive baby bottle nipple device in accordance with the present invention, the nipple/areola portions of the compliant infant nutritive suckling device can pass relevant nipple regulatory tests and be in compliance with relevant mechanical strength requirements - namely, requirements associated with U.S. 16 CFR 1500.51 and European regulatory standard EN 14350 (including Section 7.7.1 thereof).

In preferred embodiments of a nutritive baby bottle nipple device in accordance with the present invention, the device is constructed from elastomers, which are more preferably silicones.

In embodiments of a second aspect of the present invention—namely, a non-nutritive pacifier device—a pacifier device generally comprises a nipple portion having a proximal end and a distal end and comprising a section along its longitudinal length between the proximal end toward the distal end thereof that is completely filled but for an open interior volume defined in a longitudinal distal portion of the completely filled section. Preferably, the open interior volume has a diameter between about 2 mm and about 6 mm. This diameter can vary along the longitudinal length of the open interior volume formed in the nipple portion. Varying the diameter of this volume will change wall thickness of the nipple portion so it can be adjusted to simulate feel of the human nipple. Connected to the nipple portion at its distal end is an areola portion. In preferred designs, this areola portion is hollow and defines an open interior volume that is contiguous with the open interior volume of the nipple portion. Wall thickness of the areola portion can be varied to give sufficient solidity and rigidity to the device to resist areola collapse during use yet not be so large to compromise pliability or create unacceptable stiffness.

In embodiments of a non-nutritive pacifier device in accordance with the present invention, the pacifier device includes a mouth shield portion connected to a distal end of the areola portion. The mouth shield may have a center hole whose diameter may align with the diameter of the opening at the distal end of the areola portion.

In embodiments of a non-nutritive pacifier device in accordance with the present invention, the mouth shield portion comprises a 2-layer structure in which the proximal top layer of the mouth shield is constructed of the same low durometer elastomer as the nipple portion and the areola portion. That elastomer having a hardness between about Shore A1 to about Shore A30. Still further, the distal bottom layer of the mouth shield is preferably constructed of a material having a hardness greater than that of the nipple portion, the areola portions, and the top layer of the mouth shield. In preferred embodiments, the bottom layer is made of a silicone or a hard plastic material.

In embodiments of a non-nutritive pacifier device in accordance with the present invention, the 2-layer structure of the mouth shield can be configured where the first proximal top layer of the mouth shield wraps around the outer edge of the second distal bottom layer of the mouth shield. In the alternative, the second distal bottom layer can wrap around the edge of the first proximal top layer.

In embodiments of a non-nutritive pacifier device in accordance with the present invention, the pacifier device includes a handle or tab which extends distally from the second distal bottom layer of the mouth shield and is constructed of the same material as the second distal bottom layer of the mouth shield.

In embodiments of a non-nutritive pacifier device in accordance with the present invention, the nipple and areola portions of said pacifier device have sufficient axial strength in compliance with the mechanical strength requirements of at least one of (i) U.S. pacifier regulation 16 CFR 1511; and (ii) European pacifier regulatory standard EN 1400, and preferably both standards.

These and other features of the present invention are described with reference to the drawings of preferred embodiments. The illustrated embodiments of features of the present invention are intended to illustrate but not limit the invention.

### BRIEF DESCRIPTION OF THE DRAWINGS

FIGS. 1 and 2 illustrate cross-sectional views of feeding nipple designs representative of prior art configurations.

FIG. 3 illustrates a cross-sectional view of a single-piece prior art elastomer pacifier configuration.

FIG. 4 illustrates a cross-sectional view of an elastomer nipple portion plus hard plastic mouth shield portion for a prior art pacifier configuration.

FIG. 5 illustrates a cross-sectional view of a prior art pacifier configuration having an elastomer nipple plus mouth shield having an imbedded hard plastic or stiff elastomer molded insert.

FIG. 6 illustrates a cross-sectional view of a nipple pulling into a collar before being screwed onto a baby bottle depicting the concept of pull through.

FIG. 7 illustrates a cross-sectional view of the nipple and collar of FIG. 6 depicting the initiation of pull through.

FIGS. 8 and 9 illustrate cross-sectional views of nipple attachment, collar and bottle combinations representative of prior art configurations.

FIG. 10 illustrates a cross-sectional view of a first embodiment of a compliant infant nutritive suckling device in accordance with the present invention.

FIGS. 11a and 11b illustrate cross-section views of a stepped-duct configuration running through a filled section of the nipple portion of the complaint infant suckling device of FIG. 10, with FIG. 11b being a close-up view of FIG. 11a.

FIG. 12 illustrates a cross-sectional view of an embodiment depicting the nipple base attachment of a nutritive suckling device, collar and bottle combination in accordance with the present invention.

FIG. 13 illustrates a cross-sectional view of an embodiment of a non-nutritive pacifier design in accordance with the present invention.

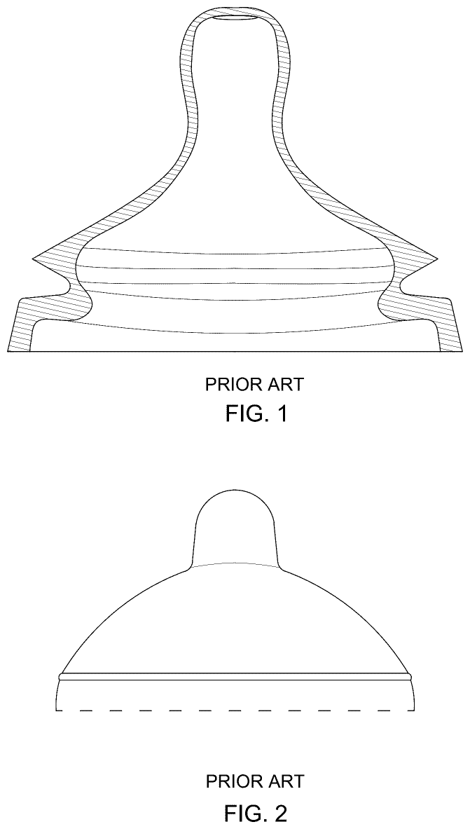

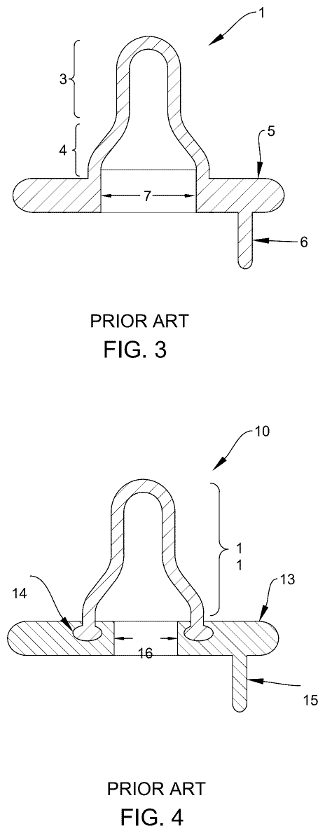

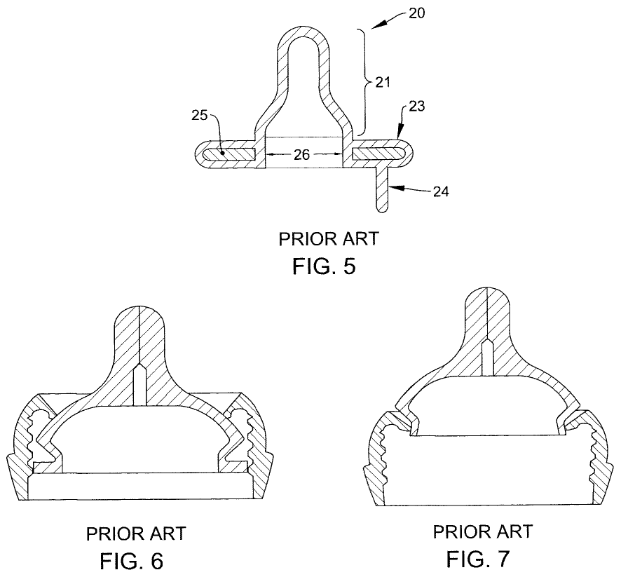

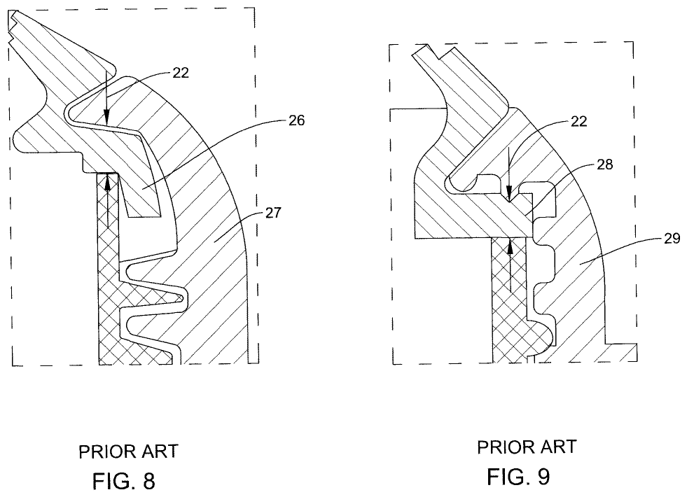

### DETAILED DESCRIPTION OF EMBODIMENTS OF THE INVENTION

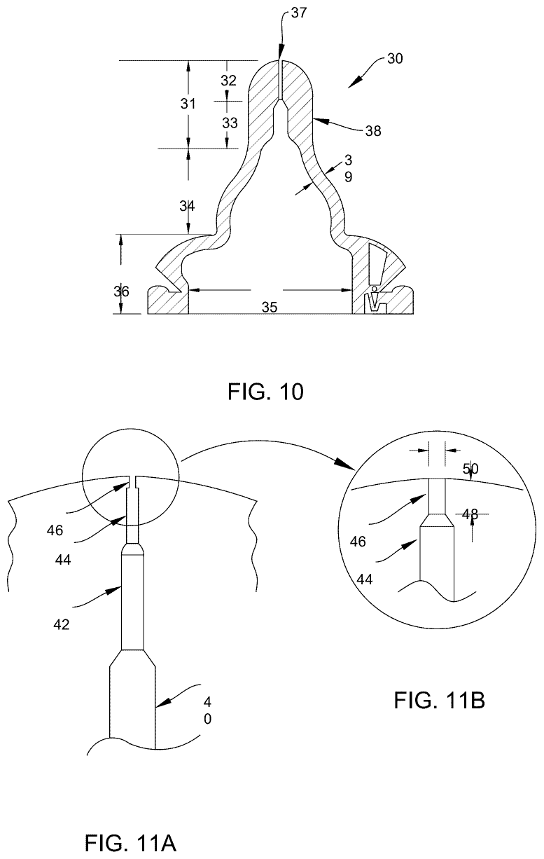

As used herein, the terms “proximal” and “distal” are used in their medical sense and directionally with respect to the user. Thus, the “proximal end” of a feeding nipple or pacifier is the portion closest to the infant, while the “distal end” is the portion farthest from the infant. A “teat” is taken to mean the entire feeding device, namely, with reference to nutritive nipple device (30) illustrated in FIG. 10: the nipple portion (31), the areola portion (34), and the base portion (36), including the nipple base attachment. In designs where there is no distinct break between the nipple portion and the areola portion, the “nipple portion” will be deemed to extend distally to 125% of the maximum diameter of the nipple portion.

The term “diameter” may be used to describe the nipple duct, the open interior volume of a partially filled nipple, the exterior cross-section of a nipple portion, areola portion or base portion of a nipple device, or similar portions of a pacifier device. This term is used only as a general descriptor and must not be taken as limiting the geometric cross sections to circular shapes. They may be oval, or other shapes, without departing from the principles and spirit of the present invention.

Describing the feeding teat nipple portion as “completely filled” or as a “filled portion” means that the nipple portion is solid but for the presence of the one or more duct(s) running through the “completely filled” nipple portion.

The following descriptions of the figures will convey details of the design and construction of nutritive and non-nutritive infant suckling devices in accordance with embodiments of the present invention. As noted, nutritive suckling devices generally relate to baby bottle nipples or teats, while non-nutritive suckling devices generally relate to pacifiers.

As noted, the human nipple functions for both nutritive and non-nutritive suckling, and, in alternating between these two functions, the nipple does not change properties. To mimic these two functions, the present invention has two major subdivisions: (1) an artificial teat or bottle-feeding nipple designed for nutritive suckling; and (2) a pacifier device designed for non-nutritive suckling. In accordance with the present invention, both devices have sufficiently high strength to resist biting damage and elongation tearing failure in regulatory testing or in use and have a sufficiently soft pliable nipple portion, respectively to provide for compression shutoff, or improved conformance to the shape of the infant's oral cavity. Additionally, each replicates properties of the human nipple and muscle action of human suckling with the only difference that, like the human nipple, one delivers nutritive fluid whereas the other does not, but does provide calming.

In embodiments of a first aspect of the present invention—a baby bottle nipple device for nutritive suckling—a nutritive suckling device is provided which is axially strong and bite-resistant yet retains deformability both longitudinally, for proper in-mouth positioning, and transversely, as required for compression shutoff. According to embodiments of the present invention, FIG. 10 illustrates a nutritive infant suckling device, generally designated as reference numeral (30), comprising a nipple portion (31), an areola portion (34) having a wall thickness (39), and a base portion (36). In preferred embodiments, such as illustrated, the nipple portion (31) has a proximal end, a distal end, and an exterior surface (38), with a portion of the nipple portion (31) at the proximal end thereof being completely filled (i.e., a “completely filled portion” or “filled portion” generally designated as reference numeral (32)) at least 4 mm along a longitudinal length from the proximal tip toward the distal end of the nipple portion (31) and having one or more duct(s) (37) extending longitudinally through the filled part (32) of the nipple portion (31). The remainder of the nipple portion (31) towards the distal end thereof is partially filled (i.e., a “partially filled portion” generally designated as reference numeral (33)) from the completely filled distal end of the nipple portion (31) to the distal end of nipple portion (31). An open interior volume in the partially filled portion (33) is formed which is contiguous with the distal end of the completely filled nipple portion (32) and the at least one duct (37) which is longitudinally disposed within the filled nipple portion (32). The partially filled section (33) of the nipple portion (31) comprises a wall thickness which can be adjusted to simulate the feel of a human nipple.

The exterior surface (38) of the nipple portion (31) can be cylindrical or oval-shaped, although other shapes are possible without departing from the principles and spirit of the present invention. The nipple portion (31) is preferably constructed from a single low durometer elastomer having a hardness of about Shore A1 to about Shore A30 and having properties and cross-sectional areas sufficient to impart axial strength sufficient to withstand regulatory testing and expected biting damage and/or elongation tearing by an infant without compromising longitudinal deformability and radial compressibility, while retaining sufficient radial compliance to allow shutoff of fluid flow through the at least one duct (37) with <8 PSI transverse compressive pressure.

In embodiments of a nutritive baby bottle nipple device in accordance with the present invention, the nipple/areola portions of the compliant infant nutritive suckling device can pass relevant nipple regulatory tests and be in compliance with relevant mechanical strength requirements—namely, requirements associated with U.S. 16 CFR 1500.51 and European regulatory standard EN 14350 (including Section 7.7.1 thereof).

In embodiments of a nutritive baby bottle nipple device in accordance with the present invention, the diameter of the at least one duct (37) of the device (30) can vary between distal and proximal ends of the filled nipple portion (32), provided there is a portion of the at least one duct (37) with a small diameter and short length acting to control fluid flow rate through the at least one duct (37).

In embodiments of a nutritive baby bottle nipple device in accordance with the present invention, the at least one duct (37) of the nutritive suckling device (30) has a wider diameter at the distal end of the filled nipple portion (32) than at the proximal end of the filled nipple portion (32). Still further, the diameter of the at least one duct (37) preferably reduces from the distal end of the filled nipple portion (32) to the proximal tip of the filled nipple portion (32) gradually or in steps. There may be one or more intermediate sections each having respective diameters between the largest and smallest diameters.

In embodiments of a nutritive baby bottle nipple device in accordance with the present invention, a fluid flow control zone of the at least one duct (37) of the nutritive suckling device (30) is located at or proximate to the extreme proximal end of the filled portion (32) of the nipple portion (31). Such a fluid control zone can be provided by a small orifice at the tip of the nipple device (30). Positioning this small orifice at the nipple tip helps control dripping.

Referring to FIGS. 11a and 11b, in preferred embodiments of the nutritive suckling device (FIG. 10) in accordance with the present invention, one or more ducts (37) each preferably have a stepped design, with tapered transitions, as illustrated. A tapered design or other configurations for forming a fluid control zone can be used without affecting the principles and spirit of the present invention. As illustrated in FIG. 11a, the diameter of the at least one duct (37) of the present bottle nipple is varied (e.g., sections (40), (42), (44) and (46)) between the distal and proximal ends of the completely filled nipple portion (32). More particularly, as illustrated, the duct (37) has a wider diameter at the distal end of the completely filled nipple portion (32)—as depicted by section (40)—than at the proximal end of the completely filled nipple portion (32)—as depicted by section (46). There may be one or more intermediate sections (e.g., sections (42), (44) in FIG. 11a), each having diameters between the largest and smallest diameters. As further illustrated in FIG. 11a, the diameter of the duct (37) is reduced in steps from the distal end to the proximal end of the filled nipple portion (32); a gradual reduction in diameter is also possible.

As illustrated in FIG. 11b, the duct section with the smallest diameter section—namely, section (46)—preferably has a diameter width (50) and a length (48) define a fluid flow control zone that acts to control fluid flow rate through the duct (37) during nursing. This fluid flow control zone may be located at any point along the duct (37), however, having this fluid flow control zone at the nipple proximal tip, as illustrated, allows surface tension across the small orifice to decrease drip.

Flow control duct diameters can be as small as 0.25 mm. Manufacturing such a small diameter duct is difficult due to the forceful injection molding processes used in the art. Typically, nipple ducts are created during molding by using duct pins. A known problem in the art generally has been that very small diameter duct pins (such as those needed to form section (46) in FIG. 11a) are susceptible to breakage under the pressure and velocity of injected polymer during injection molding. To address this manufacturing problem, each of the larger diameter duct pin sections of the present embodiments provide mechanical support to the smaller, more fragile, duct pin sections proximal to them. As a result, the duct configuration of the present invention allows nipple manufacture with small, fragile flow-control duct pins which would otherwise suffer unacceptable breakage if they were extended and unsupported through the entire >4 mm length of the completely filled nipple portion (32).

Referring again to FIG. 10, the nipple portion (31) of the compliant nutritive suckling device is connected at its distal end to an areola portion (34) which has an open interior volume. The areola portion (34) has a maximum diameter that is at least 125% of the maximum diameter of the nipple portion (31).

In embodiments of a nutritive baby bottle nipple device in accordance with the present invention, the nipple portion (31) is connected at its distal end to the hollow areola portion (34) such that the open interior volume of the areola portion (34) connects to the open interior volume within the partially filled portion (33) at the distal end of the nipple portion (31) which connects to the distal end of the at least one duct (37), as illustrated in FIG. 10. The opening at the distal end of the areola portion (34) connects to an opening (35) through the base portion (36) of the nipple device (30) so there is a continuous fluid path from the opening (35) through the base portion (36) to the at least one duct (37) in the nipple portion (31). The areola portion (34) is preferably constructed of the same material as the nipple portion (31), that is a low durometer elastomer having a hardness of about Shore A1 to about Shore A30. The hollow areola portion (34) has a wall thickness (39) that provides radial pliability generally replicating areola properties of a natural nipple.

In embodiments of a nutritive baby bottle nipple device in accordance with the present invention, the nipple portion (31) and areola portion (34) have sufficiently narrow external shapes that the infant can establish a deep latch pulling the nipple deep into its mouth. In addition, the nipple portion (31) and areola portion (34) may be constructed of a stretchy elastomer to allow the infant to adjust in-mouth nipple/areola length for proper positioning at the back of the mouth.

In embodiments of a nutritive baby bottle nipple device in accordance with the present invention, the areola portion (34) is connected at its distal end to the base portion (36). The base portion (36) is preferably constructed of the same single elastomer as the nipple portion (31) and the areola portion (34)—namely, within the range of about Shore A1 to Shore A30. The base portion (36) in FIG. 10 has an opening (35) that connects to the opening at the distal end of the areola portion (34), so there is a continuous fluid path from the opening in the nipple base portion (36) to the at least one duct (37).

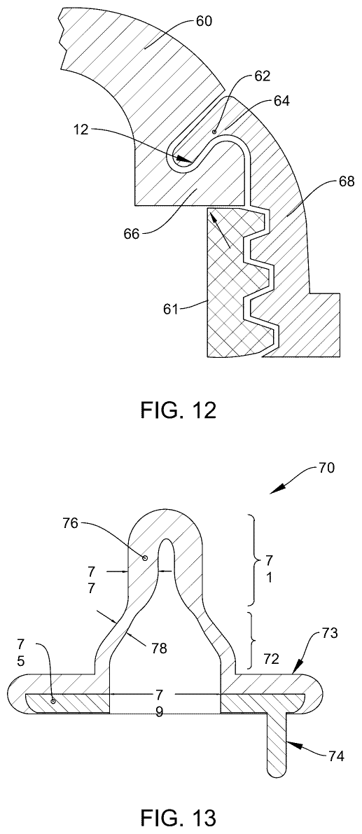

Referring to FIG. 12, a base attachment design in accordance with the present invention for sealingly connecting the teat (60)—such as the nutritive baby bottle nipple device (30) illustrated in FIG. 10—to a bottle (61) using a purpose-designed collar (68), said attachment design being capable of carrying a 20-pound axial load without the teat (60) becoming detached from the bottle (61). To resist pull through—as depicted in FIGS. 6 and 7—the collar (68) has an angled, downward projecting finger (62). When the nipple (60) is pulled into the collar (68), the downward projecting finger of the collar securely seats into the matching angled groove (64) of the nipple (6) resisting pull through. After the teat (60) and collar (68) are screwed onto the bottle (61), sufficient material outbound of the pinch point (marked by arrows (22)) is provided in both amount—as generally depicted by an extended nipple base rim (68)—and shape—as generally depicted by an angled groove (64) formed in the nipple (60) that engages a complementary angled projection (62) on the collar (68)—to resist pullout of the teat (60) from the collar (68).

In embodiments of a nutritive baby bottle nipple device in accordance with the present invention, an infant nutritive suckling device (30) having material properties and physical geometry that require the infant to apply the same oral mechanics as in breastfeeding and having sufficient radial compressibility to allow a compressive force of less than 8 PSI applied transversely by an infant's tongue to be transmitted through the filled nipple portion (32) causing a compressive collapse of the at least one duct (37) and thereby stopping fluid flow through said at least one duct (37).

In construction of the nutritive nipple device (30) illustrated in FIG. 10, the nipple portion (31), the areola portion (34), and the base portion (36) may all be constructed from a single elastomer having a hardness between about Shore A1 to about Shore A30. The nipple and areola portions (31, 34) of the nutritive suckling device (30) should have properties and cross-sectional areas sufficient to impart bite resistance and axial strength for regulatory testing and biting damage by an infant while retaining longitudinal deformability, and sufficient radial compressibility to allow a compressive force applied transversely by an infant's tongue of 8 PSI or less to be transmitted through the filled nipple portion (32) causing a compressive collapse of the at least one duct (37) and thereby stopping fluid flow through said at least one duct (37).

As noted, the design shown in FIG. 12 addresses nipple base attachment pull through and pullout and works with very soft (e.g., Shore A1-A30) highly deformable elastomers, as well as a collar (68) made with a less expensive unscrewing tool, not an expensive collapsing core tool. In such a design, as illustrated, the teat (60) is attached to a bottle (61) using a purpose-designed collar (68). To resist pull through, the angled finger (62) on the inside of the collar and the angled nipple groove (64) around the outer edge of the nipple base both have mating angled conical tapers. As the nipple (60) is pulled into the collar (68) these two tapers, working together, serve to pull the nipple annular attachment flange radially outward, seating and holding it in the collar (68) thereby resisting pull through. To resist pullout of the very soft highly deformable elastomer, the amount of elastomer in the nipple base rim (66) outbound of the pinch point (22) is large. In testing, this attachment will hold over 20 pounds without the teat (60) pulling out of the collar (68) and becoming detached from the bottle (61).

In embodiments of a second aspect of the present invention—namely, a non-nutritive pacifier device—a pacifier device generally depicted in FIG. 13 as reference numeral (70) comprises a nipple portion (71) which is generally completely-filled but for one or more partially filled section along the longitudinal length of the nipple portion (71). In FIG. 13, the proximal end of the nipple portion is completely-filled while the distal portion includes an open interior volume. In general, the diameter of the open interior volume is between about 2 mm and about 6 mm. This diameter may vary along the longitudinal length of the open interior volume. Varying the diameter of this volume will change wall thickness of the nipple portion (71) so it can be adjusted to simulate feel of the human nipple.

Connected to the nipple portion (71) at its distal end is an areola portion (72). In preferred designs, this areola portion (72) is hollow and defines an open interior volume that is contiguous with the open interior volume of the partially filled nipple portion, if present. Wall thickness of the areola portion (72)—as represented by reference numeral (78)—can be varied to give sufficient solidity and rigidity to the device (70) to resist areola collapse during use yet not be so large to compromise pliability or create unacceptable stiffness.

A pacifier design for nonnutritive suckling is shown in FIG. 13 including the nipple portion (71) and the areola portion (72), each of which can have a hardness between about Shore A1 to A30 to produce a very compliant pacifier device (70) that simulates human tissue. As illustrated, the nipple portion (71) is generally completely filled but for one or more partially filled section along the longitudinal length of the nipple portion (71). These open interior volume sections create a wall thickness (77) which can be adjusted to simulate the feel of a human nipple. A hollow areola portion (72) is connected to the distal end of the nipple portion (71) such that the interior volume of the partially filled nipple portion connects to the interior volume of the areola portion. The wall thickness (78) of the areola portion (72) can be varied to give sufficient solidity to resist areola collapse during use but not create undue stiffness.

In the disclosed pacifier design, the same Shore A1 to A30 elastomer used to form nipple and areola portions also forms the top layer of the mouth shield (73). Having the same elastomer ensures a strong bond between nipple/areola portions and mouth shield proximal portion.

In a preferred design for the pacifier (70), a mouth shield (73) is provided and defines a central opening (79) that typically aligns with the distal opening of the interior volume of the areola portion (72). The mouth shield (73) is preferably a 2-layer structure in which a top layer, adjacent to the areola portion (72), is bonded to a bottom layer (75) having a sufficient stiffness to prevent the pacifier (70) being sucked into the infant's mouth and to meet required regulatory safety requirements. This bottom layer (75) may be constructed preferably of an elastomer having a Shore A hardness above 45; alternatively, it may be a hard plastic. The Shore A1 to A30 elastomer of the proximal top layer of the mouth shield (73) may or may not wrap around the outer edge of the bottom layer (75) of the mouth shield (73). Alternatively, the bottom layer (75) may or may not wrap around the edge of the proximal top layer of the mouth shield (73).

In the disclosed pacifier design, the same Shore A1 to A30 elastomer used to form nipple and areola portions preferably also forms the top layer of the mouth shield (73). Having the same elastomer ensures a strong bond between nipple/areola portions (71, 72) and mouth shield proximal portion (73).

Referring further to FIG. 13, the pacifier (70) includes a tab or handle (74) protruding distally from the bottom layer (75) of the mouth shield (73). The tab or handle (74) is molded as part of the mouth shield (73). Typically, the tab or handle (74) is made from the same material and has the same hardness as the bottom layer (75) of the mouth shield (73). Such a high stiffness tab or handle (74) will provide both a firm grip for easy insertion or removal of the pacifier (70) from the infant's mouth and will enable reliable attachment of a toy or pacifier strap, thereby meeting this and all the other pacifier design objectives In embodiments of the present pacifier device (70), both the nipple portion (71) and the areola portion (72) are constructed of a single low durometer elastomer having a hardness between about Shore A1 to about Shore A30 and having properties and cross-sectional areas sufficient to pass puncture of the nipple/areola portion (71, 72) with a 3 mm punch followed by a 20-pound axial pull for 10 seconds while retaining sufficient pliability to allow the device to reshape and better conform to the geometry of the infant's oral cavity. As so constructed, the pacifier (70) can pass the mechanical strength requirements of either U.S. pacifier regulatory test 16 CFR 1511 and European pacifier regulatory test EN 1400, and more preferably both.

In preferred embodiments for the pacifier device of the present invention, the elastomeric materials used are preferably silicone.

In preferred embodiments of the non-nutritive pacifier device (70), the top layer and the bottom layer (75) of the mouth shield (73) are strongly bonded e.g., by self-bonding between chemically similar elastomers. If the bottom layer (75) is hard plastic, bonding between the elastomer top layer and hard plastic bottom layer can be accomplished by, for example, using reactive elastomers, primers or other methods known in the art. Strong bonding ensures a reliable load transfer from nipple to tab avoiding separation which could create a choking hazard.

In embodiments of the non-nutritive pacifier device (70), the nipple portion (71) and areola portions (72) may be constructed from a stretchy material allowing an infant to adjust in-mouth length of the nipple and areola portions (71, 72) for desired in-mouth positioning.

In accordance with preferred embodiments, the pacifier device (70) of FIG. 13 is bite-resistant yet retains deformability both longitudinally and transversely and is capable of changing shape under the action of infant suckling such that the device better conforms to the shape of the infant's oral cavity during suckling action.

The foregoing description of embodiments of the present invention has been presented for the purposes of illustration and description. It is not intended to be exhaustive or to limit the invention to the form disclosed. Obvious modifications and variations are possible considering the above disclosure. The embodiments described were chosen to best illustrate the principles of the invention and practical applications thereof to enable one of ordinary skill in the art to utilize the invention in various embodiments and with various modifications as suited to the contemplated uses.

What is claimed is:

1. A device for nutritive infant suckling comprising:
a nipple portion having a proximal end, a distal end, and an exterior surface, and further defining:
a filled portion wherein said nipple portion is filled along a longitudinal portion of the length of said nipple portion from the proximal tip thereof toward the distal end thereof and further defining at least one duct extending generally longitudinally through the filled portion of the nipple portion, and
a partially filled portion wherein said nipple portion is partially filled along a longitudinal length extending from the distal end of the filled portion to the distal end of the nipple portion, said partially filled portion defining an open interior volume that is contiguous with a distal end of the at least one duct, and
an areola portion connected to the nipple portion at the distal end thereof, wherein said areola portion defines an open interior volume contiguous with the open interior volume of the partially filled nipple portion, and
wherein said nipple portion and areola portions are both constructed of a single low durometer elastomer having a hardness of about Shore A1 to about Shore A30.

2. The device for nutritive infant suckling according to claim 1, wherein said nipple portion and areola portions are both constructed of a single low durometer elastomer having sufficient radial compliance to allow shut off of fluid flow through the at least one duct with <8 PSI transverse compressive pressure.

3. The device for nutritive infant suckling according to claim 1, wherein the at least one duct reduces in cross-section from the distal end of the filled portion of the nipple portion to the proximal end of the filled portion of the nipple portion, wherein said reduction in cross-section comprising at least one of a gradual reduction of diameter or a stepped diameter reduction.

4. The device for nutritive infant suckling according to claim 3, wherein the largest cross-sectional diameter of the at least one duct is located at the distal end of the filled portion of the nipple portion and the smallest cross-sectional diameter of the at least one duct is located at or proximate to the proximal end of the filled portion of the nipple portion.

5. The device for nutritive infant suckling of claim 4, wherein the at least one duct further comprises one or more intermediate duct sections positioned between the largest and smallest cross-sectional diameter section, each said one or more intermediate duct sections having respective cross sections with diameters between the largest and smallest cross-sectional diameters.

6. The device for nutritive infant suckling according to claim 3, wherein the at least one duct includes a flow control zone having a cross-sectional diameter smaller than the cross-sectional diameters of all other sections of said at least one duct.

7. The device for nutritive infant suckling according to claim 6, wherein the flow control zone of the at least one duct is located at or proximate to the extreme proximal end of the filled portion of the nipple portion.

8. The device for nutritive infant suckling according to claim 1, further comprising a base portion constructed of a single low durometer elastomer having a hardness of about Shore A1 to about Shore A30, which is connected to the distal end of the areola portion and configured for connection, by a collar, to sealingly attach said base portion to a container designed to contain fluid to be fed to an infant, and
wherein the attachment configuration between base portion, collar and bottle is capable of carrying a 20-pound axial load without the teat base portion pulling out of the collar and becoming detached from the container.

9. The device for nutritive infant suckling according to claim 8, wherein the nipple portion, the areola portion and the base portion are all constructed of the same single elastomer having a hardness of about Shore A1 to about Shore A30.

10. The device for nutritive infant suckling according to claim 1, wherein said device having sufficient axial strength in compliance with the mechanical strength requirements of at least one of (i) U.S. nipple regulatory test 16 C.F.R. Section 1500.51(c); and (ii) Section 7.7.1 of European regulatory standard EN 14350.

11. The device for nutritive infant suckling according to claim 10, having sufficient radial compliance to allow shut off of fluid flow through the at least one duct with <8 PSI transverse compressive pressure.

12. The device for nutritive infant suckling according to claim 1, wherein the low durometer elastomer comprises a silicone.

13. A device for non-nutritive infant suckling comprising:
a nipple portion having a proximal end and a distal end and comprising a section along its longitudinal length between the proximal end toward the distal end thereof that is completely filled but for an open interior volume defined in a longitudinal distal portion of the completely filled section, said open interior volume having a diameter between about 2 mm and about 6 mm; and
an areola portion connected to the nipple portion at the distal end thereof, wherein said areola portion defines an open interior volume,
wherein the open interior volume of said areola portion is contiguous with the open interior volume of the nipple portion, and
wherein said nipple portion and areola portion are both constructed of a single low durometer elastomer having a hardness of about Shore A1 to about Shore A30.

14. The device for non-nutritive infant suckling according to claim 13, further comprising a mouth shield portion connected to a distal end of the areola portion.

15. The device for non-nutritive infant suckling according to claim 14, wherein the mouth shield portion comprises a 2-layer construction having a proximal top layer and a distal bottom layer,
wherein the proximal top layer of said mouth shield portion is constructed of a single low durometer elastomer having a hardness between about Shore A1 to about Shore A30 such that the nipple portion, the areola portion and the proximal top layer of the mouth shield portion are all constructed from the same single elastomer.

16. The device for non-nutritive infant suckling according to claim 15, wherein said distal bottom layer is constructed of a material having a hardness greater than the nipple portion, the areola portion and the proximal top layer of the mouth shield portion.

17. The device for non-nutritive infant suckling according to claim 16, wherein the distal bottom layer of the mouth shield portion is constructed of silicone or hard plastic.

18. The device for non-nutritive infant suckling according to claim 15, wherein one of the first proximal top layer and the second distal bottom layer of the mouth shield wraps around the outer edge of the other of the first proximal top layer and the second distal bottom layer of the mouth shield.

19. The device for non-nutritive infant suckling according to claim 15, wherein a handle or tab extends distally from the second distal bottom layer of the mouth shield and is constructed of the same material as the second distal bottom layer of the mouth shield.

20. The device for non-nutritive infant suckling according to claim 13, wherein the nipple and areola portions have properties and cross-sectional areas sufficient to pass puncture of the nipple/areola portion with a 3mm punch followed by a 20-pound axial pull for 10 seconds.

21. The device for non-nutritive infant suckling according to claim 13, wherein the nipple and areola portions of said device have sufficient axial strength in compliance with the mechanical strength requirements of at least one of (i) U.S. pacifier regulation 16 CFR 1511; and (ii) European pacifier regulatory standard EN 1400.

22. The device for non-nutritive infant suckling according to claim 13, wherein the low durometer elastomer comprises a silicone.
